(19) United States
(12) Patent Application Publication
(10) Pub. No.: US 2024/0300061 A1
(43) Pub. Date: Sep. 12, 2024

(54) NUCLEAR POWER PLANT SYSTEM

(71) Applicant: Rolls-Royce SMR Limited, Derby (GB)

(72) Inventors: Daniel ROBERTSON, Derby, Derbyshire (GB); Euan SHARP, Derby, Derbyshire (GB); Gerard HALLIDAY, Derby, Derbyshire (GB); Stephen CALVERT, Derby, Derbyshire (GB); Matthew MORRIS, Derby, Derbyshire (GB)

(21) Appl. No.: 18/254,694

(22) PCT Filed: Nov. 12, 2021
(86) PCT No.: PCT/EP2021/081548

§ 371 Date: May 26, 2023

(30) Foreign Application Priority Data
Dec. 3, 2020 (GB) 2019068.2

(51) Int. Cl. B23P 19/06; G21C 13/024; G21C 13/073; G21C 19/10; G21C 19/20

(52) U.S. Cl. CPC B23P 19/067; G21C 13/024; G21C 13/073; G21C 19/10; G21C 19/207

(57) ABSTRACT

Disclosed is a method of tensioning/detensioning closure studs of a nuclear reactor vessel. The closure studs are spaced about a circumference of the reactor vessel so as to attach an integrated head package (IHP) of the reactor vessel to a body of the reactor vessel. The method comprises supporting a first stud tensioner device on a trolley, moving the trolley across a movement surface from a stored position to a deployment position adjacent the reactor vessel, engaging the first stud tensioner device with one or more of the closure studs, and operating the first stud tensioner device to tension/detension the one or more closure studs.

### FIELD OF THE DISCLOSURE

The present disclosure relates to a method and system for tensioning and/or detensioning studs of a nuclear reactor pressure vessel.

### BACKGROUND

Nuclear power plants convert heat energy from the nuclear decay of fissile material contained in fuel assemblies contained in a reactor core into electrical energy. Water cooled reactor nuclear power plants, such as pressurised water reactor (PWR) and boiling water reactor (BWR) plants, include a reactor pressure vessel (RPV), which contains the reactor core/fuel assemblies, and a turbine for generating electricity from steam (produced by heat from the fuel assemblies).

PWR plants have a pressurised primary coolant circuit which flows through the RPV and transfers heat energy to one or more steam generators (heat exchangers) within a secondary circuit. The (lower pressure) secondary circuit comprises a steam turbine which drives a generator for the production of electricity. These components of a nuclear plant are conventionally housed in an airtight containment building, which may be in the form of a concrete structure.

The RPV typically comprises a body defining a cavity for containing the nuclear reactor (i.e. including the fuel assemblies) and a closure head for closing an upper opening to the cavity. The closure head may form part of an integrated head package (IHP) (or integrated head assembly) which further comprises a control rod drive mechanism contained within a shroud. The control rod drive mechanism comprises drive rods which pass through the closure head and are connected to control rods contained within the reactor core. The control rods are provided to absorb neutron radiation within the core and thus control the nuclear reactions within the reactor core. The drive rods within the control rod drive mechanism are powered by a power supply to vertically translate to thus raise and lower the control rods within the reactor core. The reactor core further comprises guide columns for the control rods and these, along with the associated electronics are typically called the “upper internals”.

Maintenance and refuelling is an important part of the operation of a nuclear power generation system. Maintenance is required periodically e.g. to replace old and/or damaged parts of the system. Refuelling is required periodically (e.g. every 18-24 months) in order to replace spent fuel rods within the fuel assemblies.

When performing maintenance/refuelling of the reactor core, it is necessary to remove the IHP from the RPV, thereby revealing the reactor core. The IHP is typically removably attached to the body by a plurality of closure studs (formed of nuts and bolts). Each of the IHP and body comprises an outwardly projecting circumferential flange having a plurality of holes that are circumferentially spaced so as to extend around the RPV. When the IHP is mounted to the body, the holes are aligned, bolts are received through the holes, and nuts are engaged with the bolts to secure them in the holes. The closure studs may then be tensioned by a stud tensioning device that elongates (i.e. stretches) the bolt to allow further movement of the nut along the bolt towards the flange. In this way, once released, the bolt remains in an elongated (i.e. tensioned) condition. The studs may subsequently be detensioned by elongating them (using the stud tensioning device) and unscrewing the nut away from the flange. This may allow removal of the studs (for subsequent removal of the head).

In order to perform maintenance and refuelling operations in a nuclear power generation system, an overhead crane arrangement such as a polar gantry crane having a circular runway is typically provided within the containment structure of the system. Polar cranes are necessarily large, heavy structures in order to allow the lifting of the heavy components of the nuclear power generation system. This makes polar cranes expensive to install.

During refuelling, the polar crane is typically used to move the stud tensioning device into engagement with the RPV for tensioning/detensioning bolts attaching the IHP to the body. Subsequently, the polar crane also typically lifts the IHP from the RPV body vertically upwards, moves the IHP horizontally away from the RPV body and then lowers it onto a storage stand on the working floor within the containment building. The polar crane is then used to lift the upper internals which typically weigh around 15 to 50 tonnes and are radioactive. The polar crane raises the internals vertically and then horizontally before lowering them into a storage pool of water in which they are submerged. This is to provide gamma shielding around the internals during refuelling.

The reactor vessel body is typically located a significant distance below the working floor of the containment structure in order to provide a refuelling cavity above the exposed reactor core within the reactor vessel body. During removal of the IHP from the reactor vessel body, the drive rods remain connected to the control rods and protrude from the reactor vessel cavity into the refuelling cavity that is flooded with water to contain any radioactive emissions from the drive rods.

The water in the refuelling cavity also acts to shield and cool the spent fuel rods within the exposed reactor core. A height of 4 metres of water is required above the fuel rods/fuel assemblies for effective gamma shielding. Filling the refuelling cavity thus requires very large volumes of water and is thus time consuming.

The protruding drive rods and the vertical extent of the refuelling cavity drives the necessary lift height of the upper internals by the polar crane as the upper internals have to clear the vertical height of the drive rods/refuelling cavity before being moved horizontally and lowered into the storage pool.

The lift height of the polar crane at least partly dictates the height of containment structure (and thus the cost/time associated with the building of the containment structure). The risks associated with dropping components from any significant vertical height onto the reactor core are very high. The overhead travelling crane is necessarily large and heavy and requires large concrete structures to support it within the containment structure. This makes such cranes expensive to install.

There is a need for an improved nuclear power generation system which mitigates at least some of the problems associated with the known systems.

### SUMMARY

In a first aspect there is provided a method of tensioning/detensioning closure studs of a nuclear reactor vessel, the closure studs spaced about a circumference of the reactor vessel so as to attach an integrated head package (IHP) of the reactor vessel to a body of the reactor vessel, the method comprising supporting a first stud tensioner device on a trolley, moving the trolley across a movement surface from a remote stored position to a deployment position adjacent the reactor vessel, engaging the first stud tensioner device with one or more of the closure studs, and operating the first stud tensioner device to tension/detension the one or more closure studs.

By moving the stud tensioner device using a trolley instead of a crane, the nuclear plant (which the reactor vessel forms part of) may not require a crane. This may allow a reduction in the height of a containment that houses the reactor vessel, such that the containment may be faster (and more cost effective) to construct. The use of a trolley may also avoid lifting the stud tensioner device (at least to any significant height), which could otherwise result in safety issues.

Further, the transportability of a trolley is generally better than e.g. a permanently fixed crane. Thus, unlike a crane, a trolley may be transported (e.g. by tracks/rails or loaded onto a vehicle) to a plurality of nuclear plants for use in maintenance processes in those plants.

Optional features of the present disclosure will now be set out. These are applicable singly or in any combination with any aspect of the present disclosure.

The movement of the trolley may be on a movement surface. The movement may be such that the trolley substantially remains in contact with the movement surface between the stored position and the deployment position. The movement may be such that a vertical distance between the movement surface and the first stud tensioner device supported on the trolley is maintained constant as the trolley is moved from the stored position to the deployment position.

The movement of the trolley may be along a path extending substantially laterally (e.g. radially) with respect to the reactor vessel. The term “laterally” is used here to describe a direction that is generally perpendicular to a longitudinal axis of the reactor (i.e. the longitudinal axis being parallel to an elongate axis of fuel assemblies of the reactor when present). The movement surface may define a reference plane (e.g. a horizontal reference plane) that may intersect the reactor vessel and, in some embodiments, may intersect the IHP of the reactor vessel. The reference plane may be substantially vertically aligned with an upper opening in the reactor body (i.e. in which the reactor core is contained). The path along which the trolley is moved may be vertically aligned with an opening to the body of the reactor vessel and/or the IHP of the reactor vessel.

Given the scale of nuclear power generation systems, the term “substantially vertically aligned” means that the vertical spacing between the working floor and the opening to the cavity (defined by an upper end of the reactor vessel body) is less than 2 metres, e.g. 1 metre or 0.5 metres.

The movement of the trolley may be along one or more tracks or rails. Thus, the movement surface may be defined by e.g. an outer surface of a track or rail of the one or more tracks or rails. Where the trolley is moved along a plurality of tracks or rails, the trolley is moved across a corresponding plurality of movement surfaces (i.e. outer surfaces of the tracks or rails). The movement of the trolley may be along two parallel tracks or two parallel rails.

By moving the trolley along tracks or rails, the trolley may be moved along a predefined path (e.g. predefined by the tracks or rails), which may ensure (consistent) repeatability of the movement. This may facilitate automation of the method. The one or more tracks or rails may solely provide a guiding function to the trolley (i.e. direct the trolley along the predefined path) or may additionally support the trolley. The trolley may be supported above the one or more tracks or rails, or may be suspended from the one or more tracks or rails.

The trolley may be moved along a substantially linear path from the stored position to the deployment position. In this respect, the trolley may be moved along substantially linear tracks or rails. Alternatively, the trolley may be moved along a compound path formed of e.g. linear and non-linear (e.g. curved) sections.

The method may comprise mounting the first stud tensioner device to the reactor vessel once the trolley has been moved to the deployment position. The reactor vessel may comprise a mounting structure for receipt of the first stud tensioner device and the method may comprise mounting the first stud tensioner device to the mounting structure (which may, for example, be in the form of a rail or a flange that may extend circumferentially about the reactor vessel). The mounting of the first stud tensioner device may comprise mounting the first stud tensioner device to the head of the reactor vessel or the body of the reactor vessel, or both.

Mounting the first stud tensioner device to the reactor vessel may comprise moving the first stud tensioner device from the trolley to the reactor vessel. In this respect, the mounting may comprise moving the first stud tensioner relative to the trolley. Such movement may be performed by a handling device forming part of the trolley or the reactor vessel, or by a handling device separate to the trolley and the reactor vessel (e.g. the handling device may be external to the trolley and reactor vessel).

The first stud tensioner device may comprise a plurality of connected stud tensioners units. In this respect, the first stud tensioner device may be a multi-stud tensioner device. The plurality of connected stud tensioner units may be arranged in an arc about the reactor vessel when mounted thereto. The first stud tensioner device, when in the form of a multi-stud tensioner device, may be in the form of a minor arc (subtending and angle less than 180 degrees), major arc (subtending an angle more than 180 degrees) or may be substantially in the form of a semi-circle.

The method may comprise lowering the first stud tensioner device onto one or more closure studs (i.e. for engagement and tensioning/detensioning of the closure studs). The lowering may be performed by the trolley, the first stud tensioner device, the reactor vessel, or by a combination of these. For example, the mounting structure of the reactor vessel may comprise a hydraulic lift or winch for lowering the first stud tensioner device.

The method may further comprise rotating or moving the first stud tensioner device about the circumference of the reactor vessel prior to engaging the first stud tensioner device with the studs. The first stud tensioner device may be rotated or moved about the longitudinal (e.g. substantially vertical) axis of the reactor vessel. The first stud tensioner device may be rotated approximately 180 degrees about the circumference of the reactor vessel. In some embodiments, rotating or moving a stud tensioner device about the circumference of the reactor vessel may comprise mounting the stud tensioner device to a rail or flange that extend circumferentially around the reactor vessel, and moving the stud tensioner device along the flange or rail.

Where the first stud tensioner is formed of a plurality of connected elements (e.g. so as to form a chain-like structure) the stud tensioner may be moved/advanced onto and about the reactor vessel so as to progressively wrap (or snake) around the reactor vessel. In this case, the first stud tensioner may be moved (i.e. wrapped) about the entire circumference of the reactor vessel.

In other embodiments, the method may comprise rotating the first stud tensioner device after engaging the studs and tensioning/detensioning the studs. In this case, the method may comprise subsequently engaging studs aligned with the first stud tensioner device (i.e. studs not yet tensioned or detensioned by the first stud tensioner) and detension/tensioning the studs. Where the first stud tensioner device is not in the form of a semi-circle, this process may be repeated until all of the studs attaching the head of the reactor vessel to the body of the reactor vessel are tensioned/detensioned by the first stud tensioner device.

The method may further comprise supporting a second stud tensioner device on the trolley (i.e. such that both the first and second stud tensioner devices are supported on the trolley). In other embodiments the second stud tensioner device may be supported on a further trolley. The second stud tensioner device may be as described above with respect to the first stud tensioner device. The second stud tensioner device may be mounted to the reactor vessel once the first stud tensioner device has been rotated about the circumference of the reactor vessel. Thus, the rotation of the first stud tensioner device may be performed so as to provide space on the reactor vessel for the second stud tensioner device to be mounted to the reactor vessel.

In other embodiments, the first stud tensioner device may not be rotated about the reactor vessel. In such embodiments, where the first stud tensioner device does not extend fully about the reactor vessel, the method may comprise supporting the second stud tensioner device on a second trolley (i.e. the trolley on which the first stud tensioner device is supported being a first trolley). The second trolley may be provided on the opposite side of the reactor vessel to the first trolley. Thus, the method may comprise moving the further trolley from a stored position to a deployment position adjacent the reactor vessel (e.g. on an opposing side of the reactor vessel to the other trolley).

The method described above with respect to the first trolley may be employed with the second trolley. Thus, the method may comprise mounting the second stud tensioner device to the reactor vessel and engaging the second stud tensioner with one or more studs. The method may further comprise operating the second stud tensioner device to tension/detension one or more studs (e.g. aligned with the second stud tensioner).

The method may comprise locking the first and second stud tensioner devices together. Once locked together, the first and second stud tensioner devices may be lowered onto corresponding closure studs. The method may comprise operating the first and second stud tensioner devices concurrently to detension the closure studs. This may allow an even tensioning/detensioning of the closure studs.

The method may further comprise removing the studs from the reactor vessel (e.g. removing the bolts and nuts from the reactor vessel). This removal of the bolts and nuts may be performed by the or each stud tensioner device. The method may comprise storing the studs. For example the studs may be stored by the or each stud tensioner device, once detensioned.

The method may also comprise removing the head of the reactor vessel from the body of the reactor vessel. Where the stud tensioner device(s) are mounted to the head of the reactor vessel, the stud tensioner device(s) may be removed from the reactor vessel with (i.e. mounted to) the head of the reactor vessel. The head of the reactor vessel may subsequently be returned to the reactor vessel and attached to the body of the reactor vessel (with the stud tensioner device(s) still mounted thereto).

As should be appreciated, the method may be performed in the reverse to remove the stud tensioner device(s) from the reactor vessel. Thus, the method may subsequently comprise disengaging the stud tensioner device(s) from the one or more studs and de-mounting the stud tensioner(s) from the reactor vessel so as to be supported on the trolley(s). The or each trolley may be moved from the deployment position to a stored position.

Where the stud tensioner is in the form of a chain-like structure (as discussed above), the removal process may comprise retracting the stud tensioner from a position in which it is wrapped around the reactor vessel to a position in which it is supported on a trolley.

The body of the reactor vessel may comprise a reactor core that may contain a control rod assembly and upper internals for guiding the control rod assembly. The IHP may comprise a closure head and a control rod drive mechanism housed within a shroud. The control rod drive mechanism may comprise at least one drive rod (and preferably a plurality of drive rods) extending through the closure head. The method may further comprise (e.g. once the studs of the IHP are removed) decoupling the at least one drive rod from the control rod assembly. The method may subsequently comprise moving the at least one drive rod into a maintenance/refuelling position in which it is stored in the IHP, and lifting the IHP away from the body, with the at least one drive in the maintenance/refuelling position.

In this way, the need for a flooded refuelling cavity may be removed as there will be no radioactive drive rods left protruding from the reactor core when the IHP is removed.

The reactor vessel may be a reactor pressure vessel forming part of a pressurised water reactor (PWR) nuclear plant. The PWR plant may comprise a plurality of steam generators spaced laterally from the reactor vessel. The movement of the trolley from the stored position to the deployment position may comprise moving the trolley between two (adjacent) steam generators. Thus, the rails or tracks may pass between the two (adjacent) steam generators.

In a second aspect there is disclosed a trolley for transporting one or more stud tensioner devices in a nuclear plant, the trolley comprising a support frame for supporting a stud tensioner device; a plurality of wheels rotatably mounted to the frame; and a handling device mounted to the frame so as to be movable with respect to the frame, the handling device configured to engage and move the stud tensioner relative to the support frame.

As should be appreciated, the trolley of the second aspect may be used to perform the method of the first aspect. In this respect, the provision of a handling device on the trolley may allow a stud tensioner device (that is supported on the frame) to be moved from the trolley to a reactor vessel (so as to be mounted to the reactor vessel). In this way, the process of mounting the stud tensioner device (including moving the stud tensioner device to the reactor vessel) may be automated. This may avoid (or at least reduce) manual handling of the stud tensioner device (which may result in a safer process).

Further, and is discussed above, the transportability of a trolley is generally better than e.g. a permanently fixed crane. Thus, unlike a crane, a trolley may be transported (e.g. by tracks/rails or loaded onto a vehicle) to a plurality of nuclear plants for use in maintenance processes in those plants.

The support frame may comprise an elongate gantry to which the handling device is movably mounted so as to be movable along a longitudinal axis of the gantry. The handling device may comprise wheels and the gantry may comprise a rail or tracks that allow the handling device to move therealong. In this respect, the handling device may be able to travel along a substantially linear axis relative to the support frame. The gantry may extend substantially horizontally.

The support frame may comprise a base for supporting the stud tensioner device thereon. The wheels rotatably mounted to the frame may be mounted to the base. The gantry may be disposed above, and may be spaced from, the base.

The wheels rotatably mounted to the support frame may form part of wheel assemblies for mounting the wheels to the base. The wheel assemblies may each comprise an axle, bearings, etc. The trolley may comprise two pairs of wheels (e.g. a forward wheel pair and rearward wheel pair) spaced from one another. In other embodiments, the wheels of the support frame may be configured for engagement with rails suspended above the ground (or floor surface). In this respect, the wheels may be mounted above the base of the support frame. The wheels may be configured to engage with (i.e. to roll across) rails or tracks located above the trolley, such that the trolley is suspended from the rails or tracks in use.

The handling device may comprise a winch. The winch may comprise an engagement member for engaging the stud tensioner and moving the stud tensioner along a substantially vertical axis. When combined with the gantry, the handling device may thus be able to lift the stud tensioner (from being supported on the support frame) and move the stud tensioner along the support frame (e.g. so as to move it towards the reactor vessel). The winch may comprise a motor such that it can be controlled electronically (e.g. remotely or in a predefined automated manner).

The handling device may otherwise comprise a robotic arm (e.g. mounted to the support frame of the trolley). Alternatively, the handling device may comprise a conveyor (e.g. a conveyor belt) for moving a stud tensioner relative to the trolley. Where the stud tensioner has a chain-like structure (i.e. formed of a plurality of connected elements), the handling device may comprise a stud tensioner unloading means configured to progressively move (i.e. advance) the stud tensioner from the trolley to a reactor vessel. For example, the unloading means may comprise one or more driven rollers (for engagement with the stud tensioner) to progressively mount (e.g. by pushing) the stud tensioner to the reactor vessel.

The trolley may comprise driving means (e.g. one or more motors) for driving the wheels. The trolley may further comprise a controller for controlling the driving means. The controller may be operated remotely (via e.g. a remote user interface and a wired or wireless connection) and/or may be operated according predefined instructions stored in a memory. The handling device may be moved in a similar manner (i.e. by one or more motors controlled remotely or according to predefined instructions). In this way, the trolley may be used as part of an automated process.

The trolley may be collapsible. That is, the trolley may be configured to be moveable between a collapsed configuration and an expanded configuration. This may be facilitated, for example, by a structure of the trolley (such as the frame) comprising telescoping, pivoting or hinged components. The trolley may include actuators for converting the trolley between the collapsed and expanded configurations. In the collapsed configuration the height and/or width of the trolley may be less than in the expanded configuration. The trolley may be movable (e.g. drivable) in the collapsed configuration. In this way, when the trolley is required to be moved through an opening e.g. in a wall of a structure containing the reactor vessel and/or into and out of the containment structure, the size of the opening (i.e. to accommodate the device) may be minimised. Thus, the trolley may be transported in the collapsed configuration and may perform the tensioning/detensioning operation in the expanded configuration. In a third aspect there is provided a nuclear reactor vessel comprising: a body defining a cavity for containing a nuclear reactor and an IHP for closing an opening to the cavity, the IHP removably attached to the body by a plurality of closure studs spaced about a circumference of the reactor vessel and extending through apertures formed in respective outwardly projecting circumferential flanges of the body and IHP; and a mounting structure for supporting a multi-stud tensioning device, the mounting structure extending circumferentially about the IHP above the closure studs.

The mounting structure may comprise a rail, track, flange, or protrusion extending circumferentially about the IHP. The mounting structure may be vertically spaced above the flange of the IHP. The mounting structure may be in the form of a rail. The rail may be spaced from the reactor vessel by radially extending supports.

The mounting structure may be configured to allow movement of the multi-stud tensioner device in a circumferential direction about the reactor vessel when mounted thereto. The mounting structure may comprise a track or rail for engagement with e.g. wheels of a mounted stud tensioner, to guide the stud tensioner in a circumferential movement about the IHP. Alternatively or additionally, the mounting structure may comprise wheels for engagement with a track or rail of a stud tensioner mounted thereto.

The reactor vessel may comprise driving means for moving a stud tensioner, when mounted thereto, circumferentially about the reactor vessel (e.g. circumferentially about the IHP). The driving means may be in the form of one or more motors or actuators. The driving means may be engagable with a mounted stud tensioner directly or via e.g. the mounting structure. The driving means may, for example, comprise a winch and a cable for engagement with a stud tensioner, whereby retraction of the cable (by the winch) provide such movement. Alternatively, the driving means may be configured to move the mounting structure about the IHP. The mounting structure may be operatively connected to the IHP via a geared arrangement (i.e. for circumferential movement of the mounting structure).

The reactor vessel may further comprise a lowering device for vertical movement of a mounted stud tensioner (i.e. mounted to the mounting structure) for engagement of the stud tensioner with one or more studs of the reactor vessel. The lowering device may engage a stud tensioner directly (e.g. may form part of the mounting structure) or may lower the mounting structure itself so as to lower the mounted stud tensioner e.g. onto one or more studs of the reactor vessel. The lowering device may be in the form of one or more winches.

In a fourth aspect there is provided a multi-stud tensioner device comprising: a plurality of stud tensioner devices for tensioning/detensioning studs on nuclear reactor vessel, the stud tensioner devices arranged so as to form an arc; and a mounting structure configured to removably mount the multi-stud tensioner device to a nuclear reactor vessel.

The multi-stud tensioner may be configured for circumferential movement about the reactor vessel to which it is mounted. Thus, the multi-stud tensioner may comprise wheels or a track or rail for movement of the multi-stud tensioner about the reactor vessel.

The multi-stud tensioner device may comprise driving means for moving the multi-stud tensioner device circumferentially about a reactor vessel when mounted thereto. In this respect, the multi-stud tensioner device may comprise one or more actuators or motors for moving the multi-stud tensioner device circumferentially about the reactor vessel. The actuators or motors may be operatively connected to wheels for moving the multi-stud tensioner device.

The multi-stud tensioner may additionally or alternatively comprise a plurality of connected chain elements (connected in series) so as to form a chain-like structure. Each element may be rotatably or pivotably connected to an adjacent element by a link. Thus, each element may be rotatable (in one or more axes) or pivotable relative to an adjacent element. Each element may comprise one or more stud tensioner devices. In this way, the stud tensioner may wrap (or snake) around a reactor vessel as it is moved onto the reactor vessel. That is, a leading element of the plurality of chain elements may be engaged with a track or rail of the reactor vessel and subsequent chain elements may be advanced onto the reactor vessel and follow the circumferential movement of the leading element (e.g. by engagement with the track or rail) as it is moved about the reactor vessel.

Alternatively, the (chain-like) multi-stud tensioner may be self-supporting and each element may comprise an actuator configured to move (e.g. rotate or pivot) the element relative to adjacent chain elements. The multi-stud tensioner may comprise (or be connectable to) a controller configured to control the actuators to cause the chain elements to wrap or snake around a reactor vessel. In another embodiment, the chain elements may be biased (by e.g. springs) so as to retain the multi-stud tensioner to the reactor vessel.

The multi-stud tensioner device may comprise a lowering device for vertical movement of the multi-stud tensioner device when mounted to reactor vessel. The lowering device may allow the multi-stud tensioner device to lower onto (and engage with) studs of the reactor vessel. The lowering device may be in the form of one or more winches.

The multi-stud tensioner device may comprise a stud removal mechanism for removing detensioned studs from the reactor vessel. The stud removal mechanism may comprise a storage compartment for storing one or more removed studs.

In a fifth aspect there is provided a nuclear plant system comprising: a nuclear reactor vessel comprising: a body defining a cavity for containing a nuclear reactor core and an IHP for closing an opening to the cavity, the IHP removably attached to the body by a plurality of closure studs spaced about a circumference of the reactor vessel and extending through apertures formed in respective outwardly projecting circumferential flanges of the body and IHP; and a mounting structure for receipt of a stud tensioner device, the mounting structure spaced above the circumferential flanges and extending circumferentially about the IHP; a trolley according to the second aspect described above, the trolley movable from a stored position to a deployment position adjacent to the reactor vessel; and a stud tensioner device configured to tension/detension the closure studs the stud tensioner device comprising a mounting portion for mounting to the mounting structure of the reactor vessel; and a containment enclosing the nuclear reactor vessel, the containment comprising one or more tracks or rails extending between a storage location and the nuclear reactor vessel, the wheels of the trolley engaged with the one or more tracks or rails for movement of the trolley between the storage location and the nuclear reactor vessel.

The containment may comprise a primary enclosure containing the nuclear reactor vessel and a secondary enclosure defining the storage location. In some embodiments the secondary enclosure may be external to the containment (e.g. may be an annex). The primary and secondary enclosures may be separated by a separating wall of the containment. The one or more tracks or rails may extend from the secondary enclosure to the reactor vessel through an opening in the separating wall. The containment may comprise a door for sealing the opening in the separating wall. The trolley and/or multi-stud tensioner device may be removable from the secondary enclosure so that the trolley and/or multi-stud tensioner device may be useable with

The system of the fifth aspect may comprise a further containment, containing a further nuclear reactor vessel and one or more tracks extending from the storage location to the further reactor vessel. In this way, the trolley (and a multi-stud tensioner device) may be moved from the storage location to the further reactor vessel and the multi-stud tensioner device may be mounted to the further reactor vessel. Thus, the trolley and multi-stud tensioner device may service a plurality of reactor vessels. The storage location may be centrally located with respect to the reactor vessels.

Each of the IHP and body of the reactor vessel may comprise an attachment portion for attachment of the IHP to the body. Each attachment portion may comprise an outwardly projecting circumferential flange. Each flange may comprise apertures therethrough for receipt of the closure studs to attach the flanges (and thus the IHP and the body) together. The IHP may comprise a pressure seal at lower end thereof for sealing the IHP with the upper end of the body.

As is set forth above with respect to the first aspect, the reactor core may contain a control rod assembly and upper internals for guiding the control rod assembly. The IHP may comprise a closure head and a control rod drive mechanism housed within a shroud. The control rod drive mechanism may comprise at least one drive rod (and preferably a plurality of drive rods) extending through the closure head. The or each drive rod may comprise a coupling element (e.g. a pneumatic coupling element) for releasably coupling to a control rod assembly within the reactor core. The at least one drive rod may be movable to a maintenance/refuelling position in which the at least one drive rod is uncoupled from the control rod assembly and at least partially (preferably fully) retracted into the IHP (e.g. into the shroud). The IHP may further comprise at least one locking element for locking the at least one drive rod in the maintenance/refuelling position.

The present invention may comprise, be comprised as part of a nuclear reactor power plant, or be used with a nuclear reactor power plant (referred to herein as a nuclear reactor). In particular, the present invention may relate to a Pressurized water reactor. The nuclear reactor power plant may have a power output between 250 and 600 MW or between 300 and 550 MW.

The nuclear reactor power plant may be a modular reactor. A modular reactor may be considered as a reactor comprised of a number of modules that are manufactured off site (e.g. in a factory) and then the modules are assembled into a nuclear reactor power plant on site by connecting the modules together. Any of the primary, secondary and/or tertiary circuits may be formed in a modular construction.

The nuclear reactor may comprise a primary circuit comprising a reactor pressure vessel; one or more steam generators and one or more pressurizer. The primary circuit circulates a medium (e.g. water) through the reactor pressure vessel to extract heat generated by nuclear fission in the core, the heat is then to delivered to the steam generators and transferred to the secondary circuit. The primary circuit may comprise between one and six steam generators; or between two and four steam generators; or may comprise three steam generators; or a range of any of the aforesaid numerical values. The primary circuit may comprise one; two; or more than two pressurizers. The primary circuit may comprise a circuit extending from the reactor pressure vessel to each of the steam generators, the circuits may carry hot medium to the steam generator from the reactor pressure vessel, and carry cooled medium from the steam generators back to the reactor pressure vessel. The medium may be circulated by one or more pumps. In some embodiments, the primary circuit may comprise one or two pumps per steam generator in the primary circuit.

In some embodiments, the medium circulated in the primary circuit may comprise water. In some embodiments, the medium may comprise a neutron absorbing substance added to the medium (e.g., boron, gadolinium). In some embodiments the pressure in the primary circuit may be at least 50, 80 100 or 150 bar during full power operations, and pressure may reach 80, 100, 150 or 180 bar during full power operations. In some embodiments, where water is the medium of the primary circuit, the heated water temperature of water leaving the reactor pressure vessel may be between 540 and 670 K, or between 560 and 650 K, or between 580 and 630 K during full power operations. In some embodiments, where water is the medium of the primary circuit, the cooled water temperature of water returning to the reactor pressure vessel may be between 510 and 600 k, or between 530 and 580 K during full power operations.

The nuclear reactor may comprise a secondary circuit comprising circulating loops of water which extract heat from the primary circuit in the steam generators to convert water to steam to drive turbines. In embodiments, the secondary loop may comprise one or two high pressure turbines and one or two low pressure turbines.

The secondary circuit may comprise a heat exchanger to condense steam to water as it is returned to the steam generator. The heat exchanger may be connected to a tertiary loop which may comprise a large body of water to act as a heat sink.

The reactor vessel may comprise a steel pressure vessel, the pressure vessel may be from 5 to 15 m high, or from 9.5 to 11.5 m high and the diameter may be between 2 and 7 m, or between 3 and 6 m, or between 4 to 5 m. The pressure vessel may comprise a reactor body and a reactor head positioned vertically above the reactor body. The reactor head may be connected to the reactor body by a series of studs that pass through a flange on the reactor head and a corresponding flange on the reactor body.

The reactor head may comprise an integrated head assembly in which a number of elements of the reactor structure may be consolidated into a single element. Included among the consolidated elements are a pressure vessel head, a cooling shroud, control rod drive mechanisms, a missile shield, a lifting rig, a hoist assembly, and a cable tray assembly.

The nuclear core may be comprised of a number of fuel assemblies, with the fuel assemblies containing fuel rods. The fuel rods may be formed of pellets of fissile material. The fuel assemblies may also include space for control rods. For example, the fuel assembly may provide a housing for a 17×17 grid of rods i.e. 289 total spaces. Of these 289 total spaces, 24 may be reserved for the control rods for the reactor, each of which may be formed of 24 control rodlets connected to a main arm, and one may be reserved for an instrumentation tube. The control rods are movable in and out of the core to provide control of the fission process undergone by the fuel, by absorbing neutrons released during nuclear fission. The reactor core may comprise between 100-300 fuel assemblies. Fully inserting the control rods may typically lead to a subcritical state in which the reactor is shutdown. Up to 100% of fuel assemblies in the reactor core may contain control rods.

Movement of the control rod may be moved by a control rod drive mechanism. The control rod drive mechanism may command and power actuators to lower and raise the control rods in and out of the fuel assembly, and to hold the position of the control rods relative to the core. The control rod drive mechanism rods may be able to rapidly insert the control rods to quickly shut down (i.e. scram) the reactor.

The primary circuit may be housed within a containment structure to retain steam from the primary circuit in the event of an accident. The containment may be between 15 and 60 m in diameter, or between 30 and 50 m in diameter. The containment structure may be formed from steel or concrete, or concrete lined with steel. The containment may contain within or support exterior to, a water tank for emergency cooling of the reactor. The containment may contain equipment and facilities to allow for refuelling of the reactor, for the storage of fuel assemblies and transportation of fuel assemblies between the inside and outside of the containment.

The power plant may contain one or more civil structures to protect reactor elements from external hazards (e.g. missile strike) and natural hazards (e.g. tsunami). The civil structures may be made from steel, or concrete, or a combination of both.

### BRIEF DESCRIPTION OF DRAWINGS

Embodiments will now be described by way of example only, with reference to the Figures, in which:

FIG. 1A is a side view of a trolley and nuclear reactor vessel according to a first embodiment;

FIG. 1B is a top view of the trolley according to the first embodiment; and

FIGS. 1C to 1F are tops views depicting a method of mounting a multi-stud tensioner to a reactor vessel according to the first embodiment; and

FIG. 2 is a schematic top view showing a trolley, multi-stud tensioner and reactor vessel according to a second embodiment.

### DETAILED DESCRIPTION

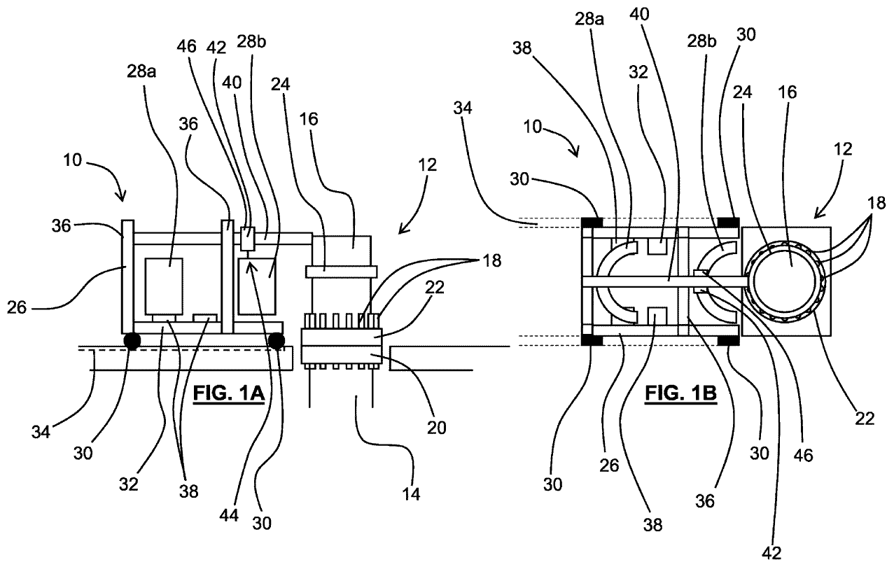

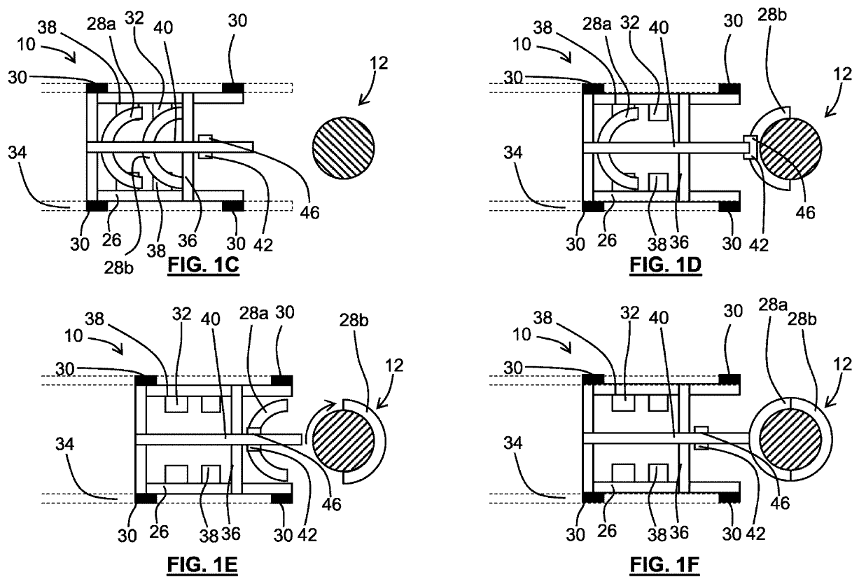

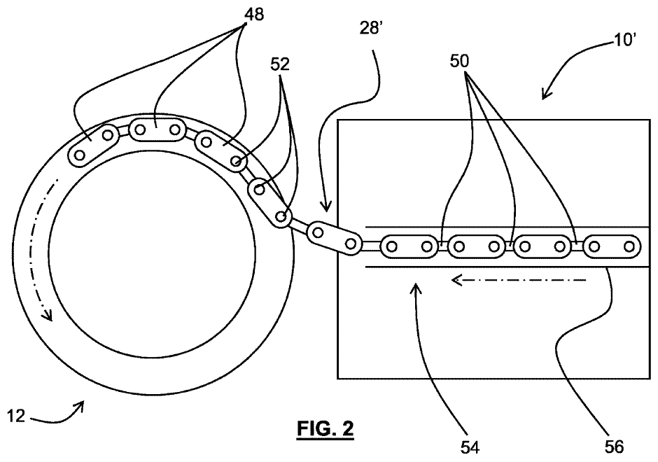

FIG. 1 illustrates a trolley 10 and a reactor pressure reactor vessel (RPV) 12, which in the illustrated embodiment forms part of a pressurised water reactor (PWR) nuclear power plant. The RPV comprises a reactor body 14 and an integrated head package (IHP) 16. The RPV 12 is positioned through an aperture formed in a floor structure such that only the IHP 16 extends above the floor structure. The IHP 16 is removably attached to the reactor body 14 by a plurality of studs 18 spaced about a circumference of the RPV 12. The studs 18 extend vertically through apertures formed in respective outwardly projecting circumferential flanges 20, 22 of the reactor body 14 and IHP 16. As will be described in more detail below, the IHP 16 further comprises mounting structure in the form of a further outwardly projecting mounting flange 24 for mounting a multi-stud tensioner device to the IHP 16.

The trolley 10 comprises a support frame 26 that, in the illustrated embodiment, is supporting first 28a and second 28b multi-stud tensioner devices (MSTs). These are described in more detail further below. The trolley 10 further comprises four wheels 30 (spaced in a rectangular arrangement) that are rotatably mounted to a base 32 of the support frame 26. The wheels 30 are received in a pair of spaced linear tracks 34 (only a portion of the track 34 is shown in the figures), which are in the form of parallel grooves formed in a floor structure. In this way, movement of the trolley 10 is restricted to a path defined by the tracks 34. Although not shown, the wheels 30 may be operatively connected to a motor for driving the wheels 30, in order to move the wheels 30 along the tracks towards and away from the RPV 12.

In the illustrated embodiment the support frame 26 comprises a plurality of horizontal and vertical elongate members 36 formed into a box-like frame. It should, however, be appreciated that the support frame 26 can take a number of different forms. The base 32 of the support frame 26 also comprises a plurality of platforms 38, on which the two MSTs 28a, 28b can be supported.

The support frame 26 also comprises a horizontally extending gantry 40 that is spaced vertically above the base 32 and extends generally centrally with between opposing lateral sides of the trolley 10. The gantry 40 extends beyond (i.e. overhangs) the base 32. As will be discussed further below, this facilitates movement of the MSTs 28a, 28b from the trolley 10 to the RPV 12.

A handling device 42 is movably mounted to the gantry 40 by way of rollers, so as to be movable in a horizontal direction along the gantry 40. The handling device 42 comprises a winch 46 having an engagement member 44 (such as an electromagnet, locking mechanism or hook) for engaging the MSTs 28a, 28b. The winch 46 is operable to move the engagement member 44 (via e.g. a wire) along a vertical axis. Thus, by way of the combination of the gantry 40 and the winch 46, the handling device 42 is able to engage and move an MST 28a, 28b in two axes. In the illustrated embodiment, the second MST 28b is engaged by the engagement member 44. The second MST 28b has been raised by the winch 46 and has been moved along the gantry 40 by the handling device 42. This movement of the handling device 42 may be provided by one or more motors (e.g. remotely controlled or following predefined instructions) forming part of the handling device 42 and/or the gantry 40.

Thus, the trolley 10 can be used to mount the MSTs 28a, 28b to the RPV 12 for the purpose of detaching the IHP 16 from the reactor body 14. The MSTs 28a, 28b are configured to tension/detension the closure studs 18 of the RPV 12. Each MST 28a, 28b comprises a plurality of stud tensioner units connected to one another and arranged in a semi-circle. In this way, each MST 28a, 28b, when mounted to the RPV 12, can tension/detension half of the closure studs 18 of the RPV 12.

An exemplary method for doing this is illustrated in FIGS. 1C to 1F. For clarity, these figures do not show the closure studs 18 or flanges 20, 22, 24 of the RPV 12.

In FIG. 1C, the trolley 10 is in the process of being moved from a stored position (not shown) along the parallel tracks 34. The trolley 10 supports the two MSTs 28a, 28b on the platforms 38 at the base 32 of the support frame 26. As discussed above, the trolley 10 may be controlled remotely or may move along the tracks 34 according to predefined instructions (i.e. in an automated manner).

In FIG. 1D the trolley 10 has arrived at the position adjacent the RPV 12. The winch 46 has been used to lift the second MST 28b from the platforms 38 and has been moved horizontally along the gantry 40 so as to move the second MST 28b towards the RPV 12.

In FIG. 1E, the second MST 28b has been mounted to the flange 24 (see FIGS. 1A and 1B) of the RPV 12 and has been rotated 180 degrees about the circumference of the RPV 12. This rotation may be performed manually, or the second MST 28b may be moved by driving means (such as a motor, winch, geared mechanism, etc.). In this figure, the winch 46 has also been moved horizontally along the gantry 40 away from the RPV 12 to the first MST 28a. The winch 46 has then been used to lift the first MST 28a from the platforms 32 and has been returned to a position on the gantry 40 proximate to the RPV 12.

In FIG. 1F, the first MST 28a has been mounted to the RPV 12 and both MSTs 28a, 28b have been locked together. Whilst not shown, the MSTs 28a, 28b can then be engaged with (e.g. lowered onto) the closure studs 18 and can be used to tension/detension the studs 18. The studs 18 can subsequently be removed, which may allow removal of the head 16 of the RPV 12 from the body 14.

FIG. 2 illustrates a trolley 10′ and a multi-stud tensioner 28′ according to a second embodiment. The multi-stud tensioner 28′ comprise a plurality of chain elements 48 connected to one another by links 50. Each chain element 48 (except for the leading and trailing chain elements 48) is pivotably engaged with two links 50. In this way, the chain elements 48 are pivotable relative to one another. Thus, the multi-stud tensioner 28′ is able to wrap or snake around the reactor vessel 12 (as is shown in the figure).

In the present embodiment, this wrapping about the reactor vessel 12 is facilitated by an unloading means 54 provided on the trolley 10′. The unloading means 54 comprises a linear guide structure (e.g. rails, tracks, etc.) 54 and an actuator or rollers (not shown) for moving or advancing the multi-stud tensioner 28′ progressively along the guide structure 54. Although not shown, trolley 10′ may comprise means for storing the multi-stud tensioner 28′ (e.g. by coiling the multi-stud tensioner 28′).

As is depicted by way of arrows in the figure, the multi-stud tensioner 28′ can be advanced onto the reactor vessel 12 and then progressively wrapped around the reactor vessel 12 by the unloading means 54 pushing the multi-stud tensioner 28′ from the trolley 10′. In order to wrap around the reactor vessel 12, the multi-stud tensioner 28′ comprises actuators that cause individual chain elements 48 to pivot relative to one another so as to form a curved/circular shape. These actuators may be controlled by a controller forming part of the multi-stud tensioner 28′, the trolley 10′ or may be remote to the trolley 10′ and the multi-stud tensioner 28′.

Each chain element 48 of the multi-stud tensioner 28′ comprises two tensioner devices 52. Thus, once the multi-stud tensioner 28′ fully encircles the reactor vessel 12 (such that the tensioner devices 52) are vertically aligned with stud of the reactor vessel 12), the multi-stud tensioner 28′ can be lowered onto the studs of the reactor vessel 12 to tension/detension the studs.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

1. A trolley for transporting one or more stud tensioner devices in a nuclear plant, the trolley comprising:
a support frame for supporting a stud tensioner;
a plurality of wheels rotatably mounted to the frame; and
a handling device mounted to the frame so as to be movable with respect to the frame, the handling device configured to engage and move the stud tensioner relative to the support frame.

2. The trolley according to claim 1 wherein the support frame comprises an elongate gantry to which the handling device is movably mounted so as to be movable along a longitudinal axis of the gantry.

3. The trolley according to claim 2 wherein the gantry extends substantially horizontally.

4. The trolley according to claim 2 wherein the support frame comprises a base for supporting the stud tensioner thereon, the gantry disposed above, and spaced from, the base.

5. The trolley according to claim 4 wherein the wheels are rotatably mounted to the base.

6. The trolley according to claim 1 wherein the handling device comprises a winch, the winch comprising an engagement member for engaging the stud tensioner and moving the stud tensioner along a substantially vertical axis.

7. A The trolley according to claim 1 wherein the support frame is configured to be convertable between a collapsed configuration and an expanded configuration.

8. A nuclear plant system comprising:
a nuclear reactor vessel comprising:
a body defining a cavity for containing a nuclear reactor core and an IHP for closing an opening to the cavity, the head removably attached to the body by a plurality of closure studs spaced about a circumference of the reactor vessel and extending through apertures formed in respective outwardly projecting circumferential flanges of the body and head; and
a mounting structure for receipt of a stud tensioner device, the mounting structure spaced above the circumferential flanges and extending circumferentially about the head;
a trolley according to claim 1, the trolley movable from a stored position to a deployment position adjacent to the reactor vessel; and
a stud tensioner device configured to tension/detension the closure studs the stud tensioner device comprising a mounting portion for mounting to the mounting structure of the reactor vessel; and
a containment enclosing the nuclear reactor vessel, the containment comprising one or more tracks or rails extending between a storage location and the nuclear reactor vessel, the wheels of the trolley engaged with the one or more tracks or rails for movement of the trolley between the storage location and the nuclear reactor vessel.

9. The nuclear plant system according to claim 8 wherein the containment comprises a primary enclosure containing the nuclear reactor vessel and a secondary enclosure defining the storage location, the primary and secondary enclosures separated by a separating wall of the containment, and wherein the one or more tracks or rails extend from the secondary enclosure to the reactor vessel through an opening in the separating wall.

10. A method of tensioning or detensioning closure studs of a nuclear reactor vessel, the closure studs spaced about a circumference of the reactor vessel so as to attach an integrated head package (IHP) of the reactor vessel to a body of the reactor vessel, the method comprising:
supporting a first stud tensioner device on a trolley;
moving the trolley across a movement surface from a remote stored position to a deployment position adjacent the reactor vessel;
engaging the first stud tensioner device with one or more of the closure studs; and
operating the first stud tensioner device to tension or detension the one or more closure studs.

11. The method according to claim 10 wherein the movement of the trolley is along a path that extends substantially laterally with respect to the reactor vessel.

12. The method according to claim 11 wherein the path extends along a substantially horizontal reference plane defined by the movement surface, the reference plane substantially vertically aligned with an upper opening in the reactor body.

13. The method according to any of-claims 10 to 12 claim 10 wherein the movement of the trolley is along one or more tracks or rails, the movement surface being a surface of the one or more tracks or rails.

14. The method according to claim 10 comprising mounting the first stud tensioner device to the reactor vessel once the trolley has been moved to the deployment position.

15. The method according to claim 14 comprising rotating the first stud tensioner device about the circumference of the reactor vessel prior to engaging the first stud tensioner device with the studs.

16. The method according to claim 15 comprising supporting a second stud tensioner device on the trolley and mounting the second stud tensioner device to the reactor vessel after rotating the first stud tensioner device about the circumference of the reactor vessel.

17. The method according to claim 16 comprising engaging the second stud tensioner device with the closure studs and operating the first and second stud tensioner devices concurrently to tension/detension a plurality of the closure studs.

18. The method according to claim 15, wherein rotating the first stud tensioner comprises mounting the first stud tensioner to a mounting structure about the circumference of the reactor vessel and moving the stud tensioner along the mounting structure.

19. The method according to claim 10 wherein the or each stud tensioner device is a multi-stud tensioner device.
